(19) United States
(12) Patent Application Publication
(10) Pub. No.: US 2013/0260041 A1
(43) Pub. Date: Oct. 3, 2013

(54) APPARATUS FOR COATING SUBSTRATE AND METHOD FOR COATING SUBSTRATE

(71) Applicant: SAMSUNG ELECTRO-MECHANICS CO., LTD., Gyeonggi-do (KR)

(72) Inventors: Cheol Kang, Gyeonggi-do (KR); Jong Hwi Kang, Gyeonggi-do (KR); Hyun Wook An, Gyeonggi-do (KR); Suk Gi Hong, Gyeonggi-do (KR)

(73) Assignee: Samsung Electro-Mechanics Co., Ltd., Gyeonggi-do (KR)

(21) Appl. No.: 13/852,971

(22) Filed: Mar. 28, 2013

(30) Foreign Application Priority Data
Mar. 29, 2012 (KR) 10-2012-0032428

(51) Int. Cl. B05D 3/12

(52) U.S. Cl. CPC B05D 3/12
USPC 427/356; 118/123

(57) ABSTRACT

Disclosed herein is an apparatus for coating a substrate, including a horizontal coating unit having an inlet and an outlet through which a substrate is moving in and out horizontally, and coating surfaces of the substrate with coating liquid by horizontal dipping method to form a protective layer; and a squeegee unit arranged outside the outlet of the horizontal coating unit and being in close contact with the protective layer of the substrate moving out of the horizontal coating unit through the outlet to uniformize coating thickness of the protective layer.

According to the present invention, coating thickness of a protective layer coated on a substrate is formed uniformly, and in particular coating quality of edges of the substrate is improved. Therefore, it is possible to minimize foreign substances introduced during manufacturing process of the substrate, thereby reducing defective rate due to foreign substances and improving productivity.

### CROSS REFERENCE(S) TO RELATED APPLICATIONS

This application claims the benefit under 35 U.S.C. Section 119 of Korean Patent Application Ser. No. 10-2012-0032428, entitled “Apparatus for Coating Substrate And Method for Coating Substrate” filed on Mar. 29, 2012, which is hereby incorporated by reference in its entirety into this application.

### BACKGROUND OF THE INVENTION

1. Technical Field

The present invention relates to an apparatus for coating a substrate, and more particularly, to an apparatus for coating a substrate by which the thickness of a protective layer coated on a substrate is formed uniformly, and in particular, coating quality of edges of the substrate is excellent, such that it is possible to minimize foreign substances introduced during manufacturing process of the substrate, thereby reducing defective rate due to foreign substance and improving productivity.

2. Description of the Related Art

As electronics industry makes progress, demand for high performance and reduction in size of electronic components is rapidly increasing. To keep pace with such trends, it is required to densify circuit patterns on substrates such as printed circuit boards, and, as a consequence, various implementation processes of fine circuit patterns have been proposed and practiced.

In addition, attempts to produce smaller sized and highly densified substrates at lower cost have been made, and, in particular, as the most important factor for reducing cost, it is considered to reduce a defective rate. Although many attempts have been made to reduce a defective rate of substrates during entire processes including manufacturing processes and assembly processes, the greatest contribution to a defective rate, i.e., a foreign substance introduced during manufacturing processes has still not been settled down.

In a manufacturing stage, a substrate is in the form of a panel and the panel is divided into a product region and a dummy region surrounding the product region.

The panel is specially processed depending on processing purposes and methods of the each step of the processes, during which quality control (specification) of a product region is performed.

However, quality control of dummy regions is not performed, and edges are likely to be damaged since most substrate manufacturing facilities implemented with conveyer systems

Damaged edges causes sources of foreign substances to accumulate and remain attached throughout the processes which contaminate substrates by moving and sticking to material and components of substrates, and resulting in a faulty production.

For this reason, in the related art, as shown in FIG. 1, a protective layer is formed on sides and edges of a substrate 1 by simply spraying coating liquid 3 on the sides and the edges of the substrate using spraying nozzles 2.

However, spraying the coating liquid 3 on the sides and the edges of the substrate 1 using the spraying nozzles 2 to form the protective layer results in problem in that the thickness of the coated protective layer has significant deviation, and coating quality degrades.

(Related Art Document) Korean Patent Laid-open Publication No. 10-2010-0037952

### SUMMARY OF THE INVENTION

An object of the present invention is to provide an apparatus and a method for coating a substrate, in which a protective layer is uniformly formed on the substrate.

Another object of the present invention is to provide an apparatus and a method for coating a substrate, in which quality of coating at edges of a substrate is improved.

According to an exemplary embodiment of the present invention, there is provided an apparatus for coating a substrate, including a horizontal coating unit having an inlet and an outlet through which a substrate is moving in and out horizontally, and coating surfaces of the substrate with coating liquid by horizontal dipping to form a protective layer; and a squeegee unit arranged outside the outlet of the horizontal coating unit and being in close contact with the protective layer of the substrate moving out of the horizontal coating unit through the outlet to uniformize coating thickness of the protective layer.

The horizontal coating unit may include a coating bath at both sides of which the inlet and outlet are arranged facing each other, and accommodating the coating liquid for forming the protective layer; and inlet rollers and outlet rollers moving the subtrate into and out of the coating bath, wherein the inlet rollers and the outlet rollers each comprises a pair of rollers, are placed at the inlet and the outlet of the coating bath, respectively, and, among each of the pairs of rollers, one roller is arranged at an upper side and the other roller is arranged at a lower side.

The horizontal coating unit may further include a main tank accommodating the coating liquid overflowing from the coating bath; and a retrieving unit continuously supplying the coating liquid into the coating bath.

The retrieving unit may include a retrieving flow path retrieving the coating liquid; a supplying flow path supplying the coating liquid; and a pump interposed between the retrieving flow path and the supplying flow path to provide flow force for retreiving and supplying the coating liquid.

The squeegee unit may include a pair of metal squeegees, wherein one of the metal squeegees is in close contact with a top surface and the other is in close contact with a bottom surface of the subtrate, and contacting pressure of the metal squeegees against the substrate is adjustable according to the coating thickness of the protective layer.

According to another exemplary embodiment of the present invention, there is provided a method for coating a substrate, including: coating, by a horizontal coating unit, surfaces of a substrate with coating liquid by horizontal dipping to form a protective layer; and uniformizing, by a sueegee unit, coating thickness of the protective layer coated on the substrate.

### BRIEF DESCRIPTION OF THE DRAWINGS

FIG. 1 is a view schematically showing a method of coating a substrate according to the related art;

FIG. 2 is a view schematically showing an apparatus for coating a substrate according to an exemplary embodiment of the present invention;

FIG. 3 is a view schematically showing a horizontal coating unit of FIG. 2; and

FIG. 4A is a photograph showing a coating quality of an edge of a substrate to which a conventional coating method is applied, and FIG. 4B is a photograph showing a coating quality of an edge of a substrate to which a coating method according to the present invention is applied, for comparison.

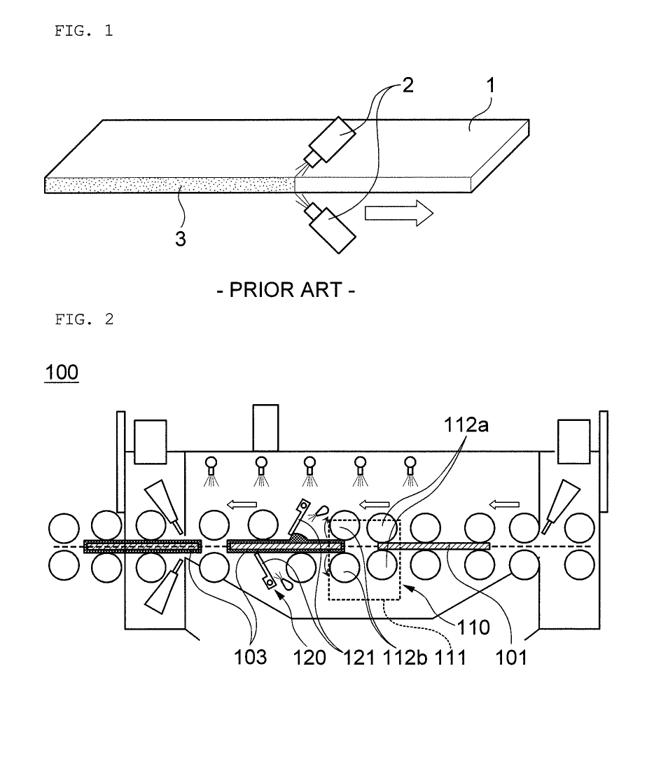

### DESCRIPTION OF THE PREFERRED EMBODIMENTS

Various advantages and features of the present invention and methods for accomplishing the same will become apparent from the following descriptions of embodiments with reference to the accompanying drawings. However, the present invention may be modified in many different ways and it should not be limited to the embodiments set forth herein. Rather, these embodiments may be provided so that this disclosure will be thorough and complete, and will fully convey the scope of the invention to those skilled in the art. Like reference numerals denote like elements throughout the description.

Terms used in the present specification are for explaining the embodiments rather than limiting the present invention. Unless specifically mentioned otherwise, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Further, the exemplary embodiments described in the specification will be described with reference to cross-sectional views and/or plan views that are ideal exemplification figures. In drawings, the thickness of layers and regions is exaggerated for efficient description of technical contents. Therefore, exemplified forms may be changed by manufacturing technologies and/or tolerance. Therefore, the exemplary embodiments of the present invention are not limited to specific forms but may include the change in forms generated according to the manufacturing processes For example, an etching region with a square shape may be rounded or may have a predetermined curvature. Furthermore, the shapes of the regions illustrated in the drawings are for illustrating specific shapes and are not for limiting the scope of the present invention.

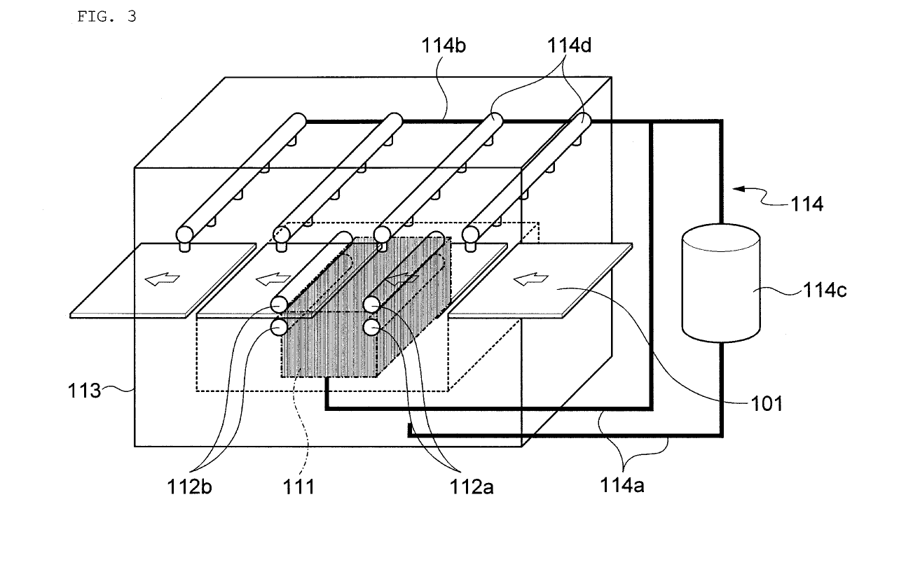

Hereinafter, an apparatus for coating and a method for coating according to an exemplary embodiment of the present invention will be described in more detail with reference to FIGS. 2 to 4B.

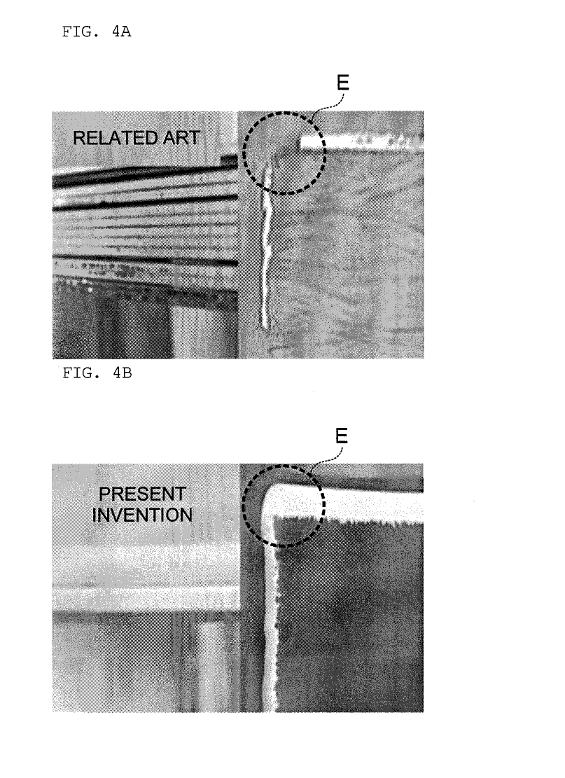

FIG. 2 is a diagram schematically illustrating an apparatus for coating a substrate according to an exemplary embodiment of the present invention; FIG. 3 is a diagram schematically illustrating a horizontal coating unit illustrated in FIG. 2; and FIGS. 4A and 4B are diagrams showing the resultant edge of a substrate coated according to a conventional coating scheme and that coated according to the coating scheme of the present invention, respectively, for comparison.

Referring to FIGS. 2 and 3, an apparatus for coating according to an exemplary embodiment of the present invention may include a horizontal coating unit 110 which forms a protective layer 103 by coating surfaces of a substrate 101 with coating liquid by a horizontal dipping method, and a squeegee unit 120 which makes the coating thickness of the protective layer 103 formed by the horizontal coating unit 110 uniform.

The horizontal coating unit 110 includes a coating bath 111, at both sides of which an inlet and an outlet for horizontally moving the substrate 101 therethrough are facing each other and in which the coating liquid for forming the protective layer 103 is stored, and inlet rollers 112a and outlet rollers 112b, which are arranged at the inlet and the outlet of the coating bath 111, respectively, with one roller of each of the pairs at an upper side and the other roller at a lower side of the substrate, so as to move the substrate 101 into or out of the coating bath 111.

The horizontal coating unit 110 may further include a main tank 113 which accommodates the coating liquid overflowing from the coating bath 111, and a retrieving unit 114 continuously supplying the coating liquid into the coating bath 111.

More specifically, the retrieving unit 114 may include a retrieving flow path 114a for retrieving the coating liquid, a supplying flow path 114b for supplying the coating liquid, and a pump 114c interposed between the retrieving flow path 114a and the supplying flow path 114b and providing flow force for retrieving and supplying the coating liquid.

The coating liquid may be directly supplied into the coating bath 111 through the supplying flow path 114b or may be supplied though a nozzle portion 114d connected to the supplying flow path 114b as in the present exemplary embodiment. Further, the nozzle portion 114d may include a plurality of nozzles for spraying particles of the coating liquid.

The squeegee unit 120 may be arranged outside the outlet of the horizontal coating unit 110, and may be in close contact with the substrate 101 moving out of the horizontal unit 110, i.e., the main tank 113 including the coating bath 111 by the outlet, i.e., outlet rollers 112b, such that the thickness of the protective layer 103 may be uniform.

The squeegee unit 120 may include a pair of metal squeegees 121 which are in close contact with the top and bottom surfaces of the substrate 101, respectively, and of which contacting pressure against the surfaces of the substrate 101 may be adjusted according to the thickness of the protective layer 103.

It is preferred that the contacting pressure of the pair of metal squeegees 121 against the substrate 101 match each other. Advantageously, the contacting pressure against the substrate 101 is adjusted so that the protective layer 103 may be formed uniformly on the substrate, thereby flexibly forming different thicknesses of the protective layer 103.

As shown in FIG. 4A, the protective layer formed on sides and edges (E) of a substrate according to the conventional spraying method has the thickness with large deviation and is not formed in certain location, thereby providing seriously poor coating quality. In contrast, as shown in FIG. 4B, the protective layer formed on sides and edges (E) of a substrate through the horizontal coating unit and the squeegee unit has the thickness with much less deviation and uniformly coated.

As stated above, according to the apparatus and method for coating a substrate of the present invention, coating thickness of a protective layer coated on a substrate can be uniform.

Further, according to the apparatus and method for coating a substrate of the present invention, quality of coating at edges of a substrate can be particularly improved.

Moreover, according to the apparatus and method for coating a substrate of the present invention, it is possible to minimize foreign substances introduced during manufacturing process of a substrate, thereby reducing defective rate due to foreign substances and improving productivity.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An apparatus for a substrate, comprising:
a horizontal coating unit having an inlet and an outlet through which a substrate is moving in and out horizontally, and coating surfaces of the substrate with coating liquid by horizontal dipping to form a protective layer; and
a squeegee unit arranged outside the outlet of the horizontal coating unit and being in close contact with the protective layer of the substrate moving out of the horizontal coating unit through the outlet to uniformize coating thickness of the protective layer

2. The apparatus according to claim 1, wherein the horizontal coating unit includes:
a coating bath at both sides of which the inlet and outlet are respectively arranged facing each other, and accommodating the coating liquid for forming the protective layer; and
inlet rollers and outlet rollers moving the subtrate into and out of the coating bath,
wherein the inlet rollers and the outlet rollers each include a pair of rollers, are placed at the inlet and the outlet of the coating bath, respectively, and, among each of the pairs of rollers, one roller is arranged at an upper side and the other roller is arranged at a lower side.

3. The apparatus according to claim 2, wherein the horizontal coating unit further includes:
a main tank accommodating the coating liquid overflowing from the coating bath; and
a retrieving unit continuously supplying the coating liquid into the coating bath.

4. The apparatus according to claim 3, wherein the retrieving unit includes:
a retrieving flow path retrieving the coating liquid;
a supplying flow path supplying the coating liquid; and
a pump interposed between the retrieving flow path and the supplying flow path to provide flow force for retrieving and supplying the coating liquid.

5. The apparatus according to claim 1, wherein the squeegee unit includes a pair of metal squeegees,
wherein one of the metal squeegees is in close contact with a top surface and the other is in close contact with a bottom surface of the substrate, and contacting pressure of the metal squeegees against the substrate is adjustable according to the coating thickness of the protective layer.

6. A method for coating a substrate, comprising:
coating, by a horizontal coating unit, surfaces of a substrate with coating liquid by horizontal dipping to form a protective layer; and
uniformizing, by a squeegee unit, coating thickness of the protective layer coated on the substrate.
